(19) United States
(12) Patent Application Publication
(10) Pub. No.: US 2015/0020349 A1
(43) Pub. Date: Jan. 22, 2015

(54) DOOR HINGE OF VEHICLE

(71) Applicant: Hyundai Motor Company, Seoul (KR)

(72) Inventor: Jong Hae LEE, Hwaseong-si (KR)

(73) Assignee: Hyundai Motor Company, Seoul (KR)

(21) Appl. No.: 14/094,624

(22) Filed: Dec. 2, 2013

(30) Foreign Application Priority Data
Jul. 17, 2013 (KR) 10-2013-0084415

(51) Int. Cl. E05F 3/20

(52) U.S. Cl. CPC E05F 3/20
USPC 16/50

(57) ABSTRACT

A door hinge of a vehicle can reduce a closing speed by generating rotational resistance only when strongly closing a door or a trunk at a predetermined speed or more. The door hinge of a vehicle may include: a door bracket coupled to a door and rotatably coupled to one side of a vehicle body bracket coupled to a vehicle body; a pawl lever pivotably assembled to the door bracket and rotating when a door closes over a predetermined speed; an anti-rotation ring pivotably assembled to the vehicle body bracket and combined with the pawl lever to operate together when the door closes over a predetermined speed; and a friction member disposed inside the anti-rotation ring and generating rotational resistance when the anti-rotation ring pivots.

### CROSS-REFERENCE TO RELATED APPLICATION

The present application claims priority of Korean Patent Application Number 10-2013-0084415 filed Jul. 17, 2013, the entire contents of which application is incorporated herein for all purposes by this reference.

### BACKGROUND OF INVENTION

1. Field of Invention

The present disclosure relates to a door hinge of a vehicle. More particularly, it relates to a door hinge of a vehicle which can reduce a closing speed by generating rotational resistance only when strongly closing a door or a trunk over a predetermined speed.

2. Description of Related Art

In general, vehicles are equipped with door hinges that help close the doors coupled to the vehicle body and prevent the doors from hanging down due to their weight. The door hinges are disposed between the doors and the vehicle body and contribute to convenience for passenger by making it easy to open/close the doors.

Door hinges of the related art have a structure with a vehicle body bracket that is coupled to a vehicle body and a door bracket that is coupled to the door connected by a hinge pin, in which the hinge pin is disposed through both of the vehicle body bracket and the door bracket.

In the door hinges of the related art, since the vehicle body bracket and the door bracket are simply connected by the hinge pin and installed, it is impossible to cope with various load conditions due to the closing speed of a door when a user closing the door.

Accordingly, the door hinges decrease satisfaction of a user due to a shock, vibration, and noise when a door is strongly closed, and they fail to normally close a door when the door is lightly closed, such that they deteriorate the commercial value of vehicles.

In particular, when a door is strongly closed over a predetermined speed, the paint of the door or the vehicle body is peeled off sometimes due to the shock.

When a parting gap between a door and a vehicle body is increased to remove the problem of the door hinges of the related art, the commercial value of a vehicle is deteriorated by the wide gap. Further, when the elastic strength of a weatherstrip is increased to absorb more shock energy in closing of a door, a user feels that a door is not closed well when closing the door at a predetermined speed, and satisfaction of the user decreases. Furthermore, when the operation force of a door checker is increased, a user feels inconvenience when closing the door at a general speed.

The information disclosed in this Background section is only for enhancement of understanding of the general background of the invention and should not be taken as an acknowledgement or any form of suggestion that this information forms the prior art already known to a person skilled in the art.

### BRIEF SUMMARY

Various aspects of the present invention provide for a door hinge of a vehicle which reduces rotational energy of a door by generating rotational resistance only when the door is strongly closed over a predetermined speed, without operating when the door is closed under the predetermined speed.

In one aspect, the present invention provides a door hinge of a vehicle, which includes: a door bracket coupled to a door and rotatably coupled to one side of a vehicle body bracket coupled to a vehicle body; a pawl lever pivotably assembled to the door bracket and rotating when a door closes over a predetermined speed; an anti-rotation ring pivotably assembled to the vehicle body bracket and combined with the pawl lever to operate together when the door closes over a predetermined speed; and a friction member disposed inside the anti-rotation ring and generating rotational resistance when the anti-rotation ring pivots.

A lever-fixing spring that is compressible in the rotational direction of the pawl lever may be disposed between one of the upper and lower ends of the pawl lever and the door bracket, and the lever-fixing spring restricts rotation of the pawl lever, with one end coupled to one end of the pawl lever.

The pawl lever may have an asymmetric structure that is rotatable by a centrifugal force, when a door closes over a predetermined speed.

The pawl lever may have an engaging protrusion at one side which engages with teeth on the anti-rotation ring, and a protrusion asymmetric to the engaging protrusion at the other side.

The pawl lever may be rotatably combined with the door bracket by a lever pin as a shaft, the anti-rotation ring is rotatably assembled to the vehicle body bracket by a hinge pin as a shaft, and the lever pin is disposed at a predetermined distance from the hinge pin.

The door hinge of a vehicle according to the present invention has following advantages.

First, it is possible to reduce the closing speed of a door by generating rotational resistance, when a door or a trunk closes strongly over a predetermined speed, such that it is possible to improve satisfaction of a consumer by preventing a shock, vibration, and peeling-off of paint when a door closes.

Second, since the door hinge does not operate, when a door and a trunk closes lightly/slowly under a predetermined speed, it is possible to ensure door-closing performance.

Third, it is possible to achieve an economical system with a simple structure without complicated electronic equipment such as a sensor and a controller.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view showing an exemplary door hinge of a door according to the present invention;

FIG. 2 is a perspective view showing the door hinge of FIG. 1, which has been assembled, according to the present invention;

FIG. 3 is a view illustrating the operation state of the door hinge of FIG. 1 according to the present invention; and

FIG. 4 is a view schematically illustrating the main effect of the door hinge of FIG. 1 according to the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The present invention relates to a door hinge that can be installed between a door and the vehicle body or the trunk and the vehicle body of a vehicle and it is assumed herein that the door includes not only the doors, but the trunk of a vehicle.

The present invention provides a door hinge having a structure that can implement selective braking with rotational resistance by operating only when the rotational speed of a door is over a predetermined speed, not operating when the rotational speed of the door is under the predetermined speed.

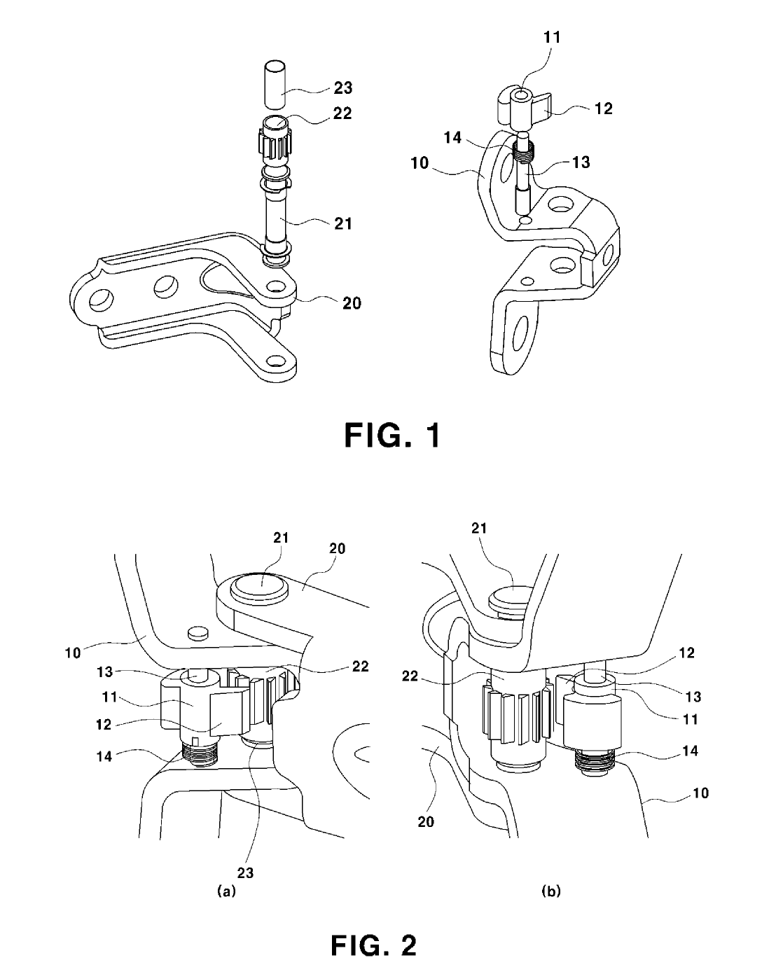

As shown in FIGS. 1 and 2, a door hinge according to various embodiments of the present invention includes a door bracket 10 and a vehicle body bracket 20 connected by a hinge pin 21, a pawl lever 11 assembled to the door bracket 10, and a anti-rotation ring 22 assembled to the vehicle body bracket 20.

The door bracket 10 is mounted on and integrally combined with a door and the vehicle body bracket 20 is mounted on and integrally combined with a vehicle body.

The hinge pin 21, which connects the door bracket 10 and the vehicle body bracket 20 with each other through them, is fixed to the vehicle body bracket 20 and supports pivoting of the door bracket 10, such that the door bracket 10 pivots on the hinge pin 21 in opening/closing of a door.

The pawl lever 11 is pivotably disposed on the door bracket 10 by a lever pin 13 and the lever pin 13 is disposed at a predetermined distance from the hinge pin 21.

The lever pin 13 is fixed to the door bracket 10, moves in the rotational direction of the door bracket 10 when a door opens/closes, and rotatably supports the pawl lever 11 on the door bracket 10.

The pawl lever 11 has an asymmetric protrusion on the outer side and is pivoted by a centrifugal force difference generated in the asymmetric protrusion when a door rotates over a predetermined speed and closes.

For example, the pawl lever 11 has an engaging protrusion 12 at one side which engages with teeth of the anti-rotation ring 22 in pivoting, and a protrusion asymmetric to the engaging protrusion 12 at the other side.

A lever-fixing spring 14 restricting rotation of the pawl lever 11 is coupled to the lower end (or the upper end) of the pawl lever 11.

The lever-fixing spring 14, which has a predetermined spring force, allows rotation of the pawl lever 11 only when a door closes over a predetermined speed.

In general, the rotational motion energy of a rotary body is proportionate to the square of a rotational speed, so the rotational motion energy of a door can be calculated by the following equation.

$$Rotational motion energy of door = \frac{1}{2} {m ( rw )}^{2} \qquad Eq . ( a )$$

In the above equation, m is the weight of the door, r is the distance from the rotational axis from the center of the weight of the door, and w is the rotational angular speed of the door.

As can be seen from the equation, the rotational force of the door is proportionate to the square of the rotational speed of the door.

Accordingly, when a door rotates under a predetermined speed and closes, the pawl lever 11 fails to rotate, not against (exceeding) the spring force (the spring force of the lever-fixing spring 14), and when a door rotates over a predetermined speed and closes, it rotates, against (exceeding) the spring force.

That is, the lever-fixing spring 14 prevents the pawl lever 11 from pivoting when a door closes under a predetermined speed, and it allows the pawl lever 11 to pivot when a door closes over a predetermined speed.

Therefore, lever-fixing spring 14 pushes the pawl lever 11 engaging with the anti-rotation ring 22 such that the pawl lever 11 rotates opposite to the rotational direction of the anti-rotation ring 22 when a door closes over a predetermined speed, such that it supports the pawl lever 11 such that the pawl lever 11 can keep engaging with the anti-rotation ring 22 while the door closes, and it returns the pawl lever 11 after the door closes.

The lever-fixing spring 14 is disposed to be compressed in the rotational direction of the pawl lever 11, between the lower end of the pawl lever 11 and the door bracket 10, and for example, one end of the lever-fixing spring 14 may be fixed to the lower end of the pawl lever 11 and the other end may be fixed to the door bracket 10.

The anti-rotation ring 22, which has a plurality of continuous teeth on the surface, is rotatably assembled to the vehicle body bracket 20, with the hinge pin 21 as a shaft.

The anti-rotation ring 22 is engaged with the pawl lever 11 to operate together by the teeth when a door closes over a predetermined speed, and it pivots with the pawl lever 11 pivoting, by the engagement with the pawl lever 11.

A friction member 23 is fixed on the outer side of the hinge pin 21, such that the anti-rotation ring 22 brakes a door rotating by generating rotational resistance from friction with the friction member 23, and accordingly, it can reduce the closing speed of the door.

The friction member 23, which generates rotational resistance when the anti-rotation ring 22 pivots, is disposed between the anti-rotation ring 22 and the hinge pin 21.

The friction member 23 has a cylindrical structure made of a friction plate having predetermined surface friction or may be implemented by a fluid damper.

The fluid damper may be any damper used in the art which can provide a damping force, using fluid therein.

When the friction member 23 a fluid damper, the anti-rotation ring 22 is rotatably fitted around the hinge pin 21 through the fluid damper, and when the anti-rotation ring 22 is pivoted by rotation of a door, rotational resistance is generated by the damping force of the fluid damper.

The door hinge having this configuration can reduce the closing speed of a door by providing a shock-absorbing force, because the pawl lever 11 engages with the anti-rotation ring 22 and provides braking, when a door is strongly closed over s predetermined speed.

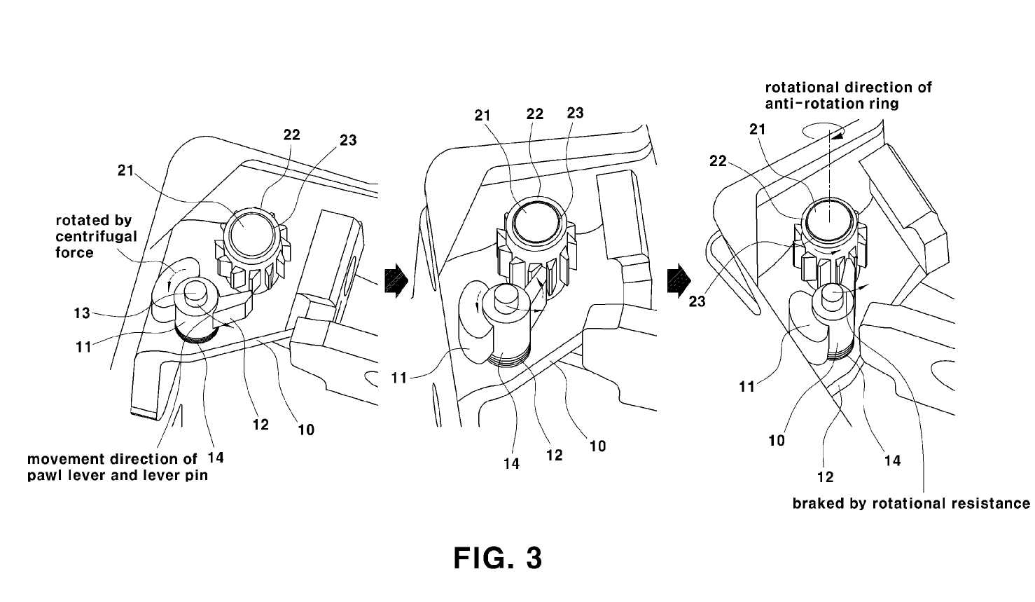

The operational state of the door hinge, when a door is strongly closed over a predetermined speed, is described in more detail below with reference to FIG. 3.

At the early stage of closing a door, as the door bracket 10 rotates about the hinge pin 21, the pawl lever 11 moves in the rotational direction of the door bracket 10 from the hinge pin 21.

The pawl lever 22 is rotated about the lever pin 13 by the centrifugal force difference due to the asymmetric structures having different mass (the engaging protrusion and the protrusion asymmetric to the engaging protrusion).

When a door closes strongly and fast over a predetermined speed, the centrifugal force exerted in the pawl lever 11 increases, such that the pawl lever 11 engages with the anti-rotation ring 22 against the spring force of the lever-fixing spring 14 and the anti-rotation ring 22 absorbs the kinetic energy of the door while rotating with the pawl lever 11.

That is, the rotational kinetic energy of the door is reduced and the door rotating is braked by the rotational resistance generated by the friction member 23 when the anti-rotation ring 22 pivots, so the closing speed of the door can be reduced.

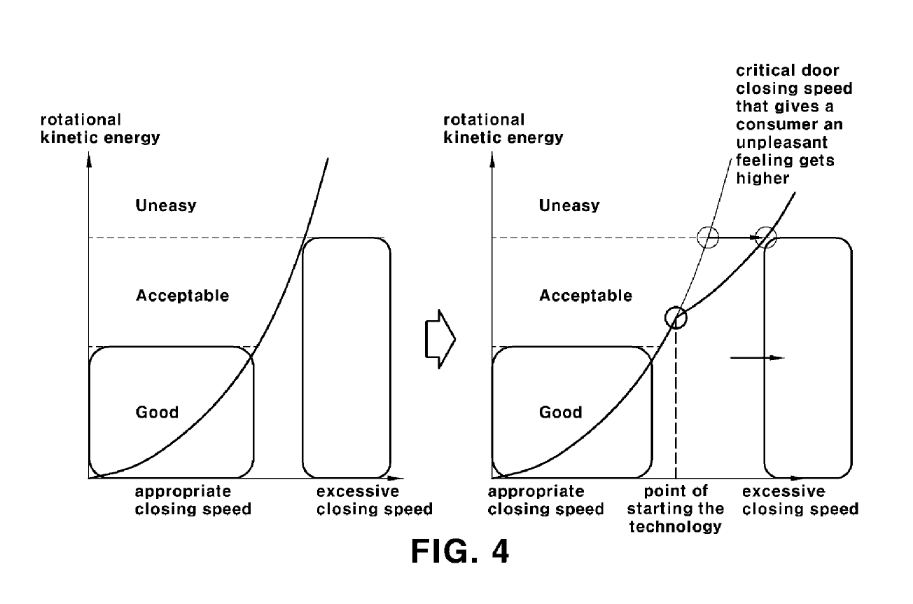

As described above, the door hinge according to the present invention reduces the rotational kinetic energy of a door and the closing speed of the door when the door closes fast over a predetermined speed, such that the critical closing speed (critical value) of a door which gives a user an unpleasant feeling in the related art is improved to be higher, and thus satisfaction of the user can be improved (see FIG. 4).

For convenience in explanation and accurate definition in the appended claims, the terms upper or lower, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A door hinge of a vehicle, comprising:
a door bracket coupled to a door and rotatably coupled to one side of a vehicle body bracket coupled to a vehicle body;
a pawl lever pivotably mounted to the door bracket and rotating over a predetermined speed when a door closes;
an anti-rotation ring pivotably mounted to the vehicle body bracket and combined with the pawl lever to operate together when the door closes over a predetermined speed; and
a friction member disposed inside the anti-rotation ring and generating rotational resistance when the anti-rotation ring pivots.

2. The door hinge of claim 1, wherein a lever-fixing spring that is compressible in the rotational direction of the pawl lever is disposed between one of the upper and lower ends of the pawl lever and the door bracket.

3. The door hinge of claim 2, wherein the lever-fixing spring restricts rotation of the pawl lever, with one end coupled to one end of the pawl lever.

4. The door hinge of claim 1, wherein the pawl lever has an asymmetric structure that is rotatable by a centrifugal force, when a door closes over a predetermined speed.

5. The door hinge of claim 1, wherein the pawl lever has an engaging protrusion at one side which engages with teeth on the anti-rotation ring, and a protrusion asymmetric to the engaging protrusion at the other side.

6. The door hinge of claim 1, wherein the anti-rotation ring has a plurality of continuous teeth on a surface thereof.

7. The door hinge of claim 1, wherein the pawl lever is rotatably combined with the door bracket by a lever pin as a shaft, the anti-rotation ring is rotatably assembled to the vehicle body bracket by a hinge pin as a shaft, and the lever pin is disposed at a predetermined distance from the hinge pin.
